(19) United States
(12) Patent Application Publication
(10) Pub. No.: US 2005/0250896 A1
(43) Pub. Date: Nov. 10, 2005

(54) Compositions for producing aminoplast products and method for producing products from these compositions

(76) Inventors: Manfred Ratzsch, Wilhering/ Thalheim (AT); Hartmut Bucka, Eggendorf (AT); Martin Burger, Linz (AT)

Correspondence Address: THE WEBB LAW FIRM, P.C., 700 KOPPERS BUILDING, 436 SEVENTH AVENUE, PITTSBURGH, PA, 15219, US

(21) Appl. No.: 10/517,962

(22) PCT Filed: Jun. 12, 2003
(86) PCT No.: PCT/EP03/06175

§ 371 Date: Jun. 30, 2005

(30) Foreign Application Priority Data
Jun. 14, 2002 (AT) A 904/2002

(51) Int. Cl. C08L 61/02

(52) U.S. Cl. 524/500; 525/398

(57) ABSTRACT

Compositions for producing aminoplast products by means of melt processing consisting of: A) 95 to 99.9% by mass of solvent-free meltable polycondensates of melamine resins having molar masses ranging from 300 to 300 000; A) from 0.1 to 5% by mass of weak acids serving as thermoinducible curing agents consisting of: acidifiers of the blocked sulfonic acid type; aliphatic C₄-C₁₈ carboxylic acids; aromatic C₇-C₁₈ carboxylic acids; alkali salts or ammonium salts of phosphoric acid; C₁-C₁₂-alkyl esters or C₂-C₈-hydroxyalkyl esters of C₇-C₁₄ aromatic carboxylic acids or of inorganic acids; salts of melamine or of guanamines having C₁₋₁₈ aliphatic carboxylic acids; anhydrides, half-esters or half-amides of C₄-C₂₀ dicarboxylic acids; half-esters or half-amides of copolymers consisting of ethylenically unsaturated C₄-C₂₀ dicarboxylic acid anhydrides and ethylenically unsaturated monomers of the C₂-C₂₀ olefin type and/or C₈-C₂₀ vinyl aromatic compounds; and/or salts of C₁-C₁₂-alkyl amines or alkanolamines having C₁-C₁₈ aliphatic, C₇-C₁₄ aromatic or alkylaromatic carboxylic acids and inorganic acids of the hydrochloric acid, sulphuric acid or phosphoric acid type, and; B) optionally up to 400% by mass of fillers and or reinforcing fibers, up to 30% by mass of additional reactive polymers of the ethylene copolymer, maleic anhyudride copolymer, modified maleic anhydride copolymer, poly(meth)acrylate, polyamide, polyester and/or polyurethane type, and up to 4% by mass, each time with regard to the polycondensates of melamine resins, of stabilizes, UV absorbers and/or auxiliary agents. These inventive compositions can be processed by means of melt processing into products such as panels, coated supporting materials, profiled pieces, pipes, injection-molded articles, fibrous products and laminates.

The invention relates to compositions for producing amino resin products and to products produced from them by melt processing. Processes for producing products from the compositions are further subject-matter of the invention.

Semi-finished products and shaped materials made from amino resins such as melamine-formaldehyde resins or melamine-urea-formaldehyde resins [Ullmann's Encyclopedia of Industrial Chemistry (1987), Vol. A2, 130-131] are known. A disadvantage associated with the production of products from melamine resins is the difficulty of their processing by common thermoplastic processing methods such as extrusion, injection moulding or blow moulding.

The melt viscosity of low molecular mass melamine resin precondensates is too low for these processing methods, and they can only be processed as highly filled moulding compounds with long cycle times and with curing of the products (Woebcken, W., Kunststoff-Handbuch Vol. 10 “Duroplaste”, Carl Hanser Verl. Munich 1988, pp. 266-274). Fibres, foams or coatings of melamine resins, owing to the low melt viscosity of the melamine resin precondensates, can be produced only starting from solutions of the melamine resin precondensates, with curing during the shaping operation.

Customary curing agents for amino resins are strong acids such as hydrochloric acid, sulphuric acid, p-toluenesulphonic acid and formic acid and also ammonium chloride (EP 0 657 496 A2; EP 0 523 485 A1, EP 0 799 260). A disadvantage with these curing agents is the inadequate cure rate in compositions with melamine resin precondensates having molar masses of 300 to 5 000 at short residence times during the melt processing of the compositions to semi-finished products and shaped materials, leading to unsatisfactory material properties.

The invention has as its object compositions of melamine resin precondensates and curing agents which are suitable for melt processing to amino resin products.

The object has been achieved by compositions for producing amino resin products by melt processing, the compositions being composed in accordance with the invention of
A) from 95 to 99.9% by mass of solvent-free meltable polycondensates of melamine resins having molar masses of 300 to 300 000,
B) from 0.1 to 5% by mass of weak acids as thermoinducible curing agents, composed of
   B1) acid formers of the type of blocked sulphonic acid of the general formula (I)
      R₁—SO₂—O—R₂ (I)
      R₁=unsubstituted or substituted aryl or biphenyl
      R₂=4-nitrobenzyl, pentafluorobenzyl or 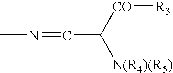
      substituents
      where
      R₃=non-substituted or substituted alkyl or aryl,
      R₄=H, C₁-C₁₂-alkyl, phenyl, C₂-C₉-alkanoyl or benzyl,
      R₅=H, C₁-C₁₂-alkyl or cyclohexyl,
   or R₃ and R₄ or R₅ together with the atoms to which they are attached form a 5- to 8-membered ring which can be fused by 1 or 2 benzo radicals,
   B2) C₄-C₁₈ aliphatic and/or C₇-C₁₈ aromatic carboxylic acids,
   B3) alkali metal salts or ammonium salts of phosphoric acid,
   B4) C₁-C₁₂-alkyl esters or C₂-C₈-hydroxyalkyl esters of C₇-C₁₄ aromatic carboxylic acids or inorganic acids,
   B5) salts of melamine or guanamines with C₁₋₁₈ aliphatic carboxylic acids,
   B6) anhydrides, monoesters or monoamides of C₄-C₂₀ dicarboxylic acids,
   B7) monoesters or monoamides of copolymers of ethylenically unsaturated C₄-C₂₀ dicarboxylic anhydrides and ethylenically unsaturated monomers of the type of C₂-C₂₀ olefins and/or C₈-C₂₀ vinylaromatics, and/or
   B8) salts of C₁-C₁₂-alkylamines and/or alkanolamines with C₁-C₁₈ aliphatic, C₇-C₁₄ aromatic or alkylaromatic carboxylic acids and also inorganic acids of the type of hydrochloric acid, sulphuric acid or phosphoric acid, and
C) if desired, up to 400% by mass of fillers and/or reinforcing fibres, up to 30% by mass of other reactive polymers of the ethylene copolymer, maleic anhydride copolymer, modified maleic anhydride copolymer, poly(meth)acrylate, polyamide, polyester and/or polyurethane type, and up to 4% by mass, based in each case on the melamine resin polycondensates, of stabilizers, UV absorbers and/or auxiliaries.

Examples of customary methods of melt processing are extrusion, injection moulding or blow moulding.

Examples of amino resin products which can be produced by melt processing are sheets, pipes, profiles, coatings, foam materials, fibres, injection mouldings and hollow articles.

The compositions for producing amino resin products can be in the form of cylindrical, lenticular, lozenge-shaped or spherical particles having an average diameter of 0.5 to 8 mm.

The polycondensates of melamine resins having molar masses of 300 to 300 000 can be polycondensates in which the triazine sequences are linked through bridge members —NH-alkylene-NH—.

Preferred melamine resins in the compositions of the invention are polycondensates of melamine and/or melamine derivatives and C₁-C₈ aldehydes with a melamine or melamine derivative/C₁-C₈ aldehyde molar ratio of 1:1.5 to 1:5 and also their partial etherification products, where the melamine derivatives can be melamines substituted by hydroxy-C₁-C₁₀-alkyl groups, hydroxy-C₁-C₄-alkyl-(oxa-C₂-C₄-alkyl)₁₋₅ groups and/or by amino-C₁-C₁₂-alkyl groups, ammeline, ammelide, melem, melon, melam, benzoguanamine, acetoguanamine, tetramethoxymethylbenzoguanamine, caprinoguanamine and/or butyroguanamine, and the C₁-C₈ aldehydes are in particular formaldehyde, acetaldehyde, trimethylolacetaldehyde, acrolein, furfurol, glyoxal and/or glutaraldehyde, with particular preference formaldehyde.

The melamine resins may likewise contain 0.1 to 10% by mass, based on the sum of melamine and melamine derivatives, of incorporated phenols and/or urea. Suitable phenol components include phenol, C₁-C₉-alkylphenols, hydroxyphenols and/or bisphenols.

The precondensates of melamine resins having molar masses of 300 to 300 000 are preferably mixtures of meltable 4- to 1 000-nucleus oligotriazine ethers,
where in the polytriazine ethers the triazine segments 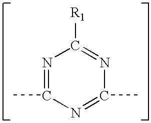
R₁=—NH₂, —NH—CHR₂—O—R₃, —NH—CHR₂—O—R₄—OH, —CH₃, —C₃H₇, —C₆H₅, —OH, phthalimido-,
   succinimido-, —NH—CO-_{C5-C18}-alkyl, —NH—C₅-C₁₈-alkylene-OH, —N H—CH R₂—O—C₅-C₁₈-alkylene-N H₂, —N H—C₅-C₁₈-alkylene-N H₂, —NH—CHR₂—O—R₄—O—CHR₂—NH—, —NH—CHR₂—NH—, —NH—CHR₂—O—C₅-C₁₈-alkylene-NH—, —NH—C₅-C₁₈-alkylene-NH—, —NH—CHR₂—O—CHR₂—NH—,
R₂=H, C₁-C₇-alkyl;
R₃=C₁-C₁₈-alkyl, H;
R₄=C₂-C₁₈-alkylene, —CH(CH₃)—CH₂—O-_{C2-C12}-alkylene-O—CH₂—CH(CH₃)—, —CH(CH₃)—CH₂—O-_{C2-C12}-arylene-O—CH₂—CH(CH₃)—, —[CH₂—CH₂—O—CH₂—CH₂]ₙ—, —[CH₂—CH(CH₃)—O—CH₂—CH(CH₃)]ₙ—, —[—O—CH₂—CH₂—CH₂—CH₂—]ₙ—, —[(CH₂)₂₋₈—O—CO—_{C6-C14}-arylene-CO—O—(CH₂)₂₋₈—]ₙ—, —[(CH₂)₂₋₈—O—CO—_{C2-C12}-alkylene-CO—O—(CH₂)₂₋₈—]ₙ—,
   where n=1 to 200;
   sequences containing siloxane groups, of the type 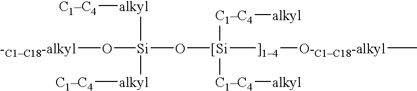
   polyester sequences containing siloxane groups, of the type —[(X)ᵣ—O—CO—(Y)ₛ—CO—O—(X)ᵣ]—,
   in which
   X={(CH₂)₂₋₈—O—CO—_{C6-C14}-arylene-CO—O—(CH₂)₂₋₈—} or
   —{(CH₂)₂₋₈—O—CO—_{C2-C12}-alkylene-CO—O—(CH₂)₂₋₈—}; 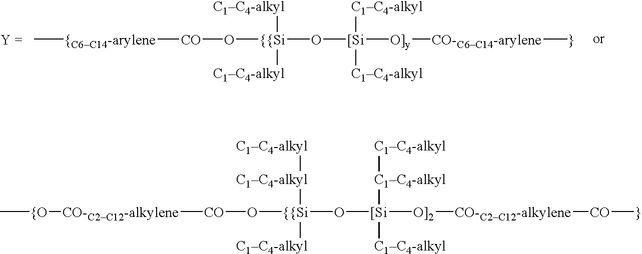
   r=1 to 70; s=1 to 70 and y=3 to 50;
   polyether sequences containing siloxane groups, of the type 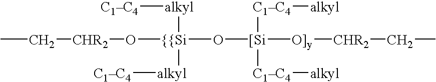
      where R₂=H; C₁-C₄-alkyl and y=3 to 50;
   sequences based on alkylene oxide adducts of melamine, of the type of 2-amino-4,6-di-_{C2-C4}-alkyleneamino-1,3,5-triazine sequences;
   phenol ether sequences based on dihydric phenols and C₂-C₈ diols, of the type of
      -_{C2-C8}-alkylene-O-_{C6-C18}-arylene-O-_{C2-C8}-alkylene- sequences;
         are linked by bridge members —NH—CHR₂—NH— or —NH—CHR₂—O—R₄—O—CHR₂—NH— and —NH—CHR₂—NH— and also, where appropriate, —NH—CHR₂—O—CHR₂—NH—, —NH—CHR₂—

O—C₅-C₁₈-alkylene-NH— and/or —NH-C₅-C₁₈-alkylene-NH— to form 4- to 1 000-nucleus polytriazine ethers with a linear and/or branched structure, in the polytriazine ethers the molar ratio of the substituents R₃:R₄=20:1 to 1:20, the proportion of the linkages of the triazine segments through bridge members —NH—CHR₃—O—R₄—O—CHR₃—NH— being from 5 to 95 mol %, and it being possible for the polytriazine ethers to contain up to 20% by mass of diols of the type HO—R₄—OH.

The terminal triazine segments in the polytriazine ethers are triazine segments of the structure 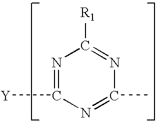
Y=—NH—CHR₂—O—R₃, —NH—CHR₂—O—R₄—OH, and also, where appropriate, —NH—CHR₂—O—C₅-C₁₈-alkylene-NH₂,
   —NH—C₅-C₁₈-alkylene-NH₂, —NH—C₅-C₁₈-alkylene-OH,
R₁=—NH₂, —NH—CHR₂—O—R₃, —NH—CHR₂—O—R₄—OH, —CH₃, —C₃H₇, —C₆H₅, —OH, phthalimido-,
succinimido-, —NH—CO—R₃, —NH—C₅-C₁₈-alkylene-OH,
—NH—C₅-C₁₈-alkylene-NH₂,
—NH—CHR₂—O—C₅-C₁₈-alkylene-NH₂,
R₂=H, C₁-C₇-alkyl;
R₃=C₁-C₁₈-alkyl, H;
R₄=C₂-C₁₈-alkylene, —CH(CH₃)—CH₂—O-_{C2-C12}-alkylene-O—CH₂—CH(CH₃)—, —CH(CH₃)—CH₂—O-_{C2-C12}-arylene-O—CH₂—CH(CH₃)—, —[CH₂—CH₂—O—CH₂—CH₂]ₙ—, —[CH₂—CH(CH₃)—O—CH₂—CH(CH₃)]ₙ—, —[—O—CH₂—CH₂—CH₂—CH₂—]ₙ—, —[(CH₂)₂₋₈—O—CO—_{C6-C14}-arylene-CO—O—(CH₂)₂₋₈—]ₙ—, —[(CH₂)₂₋₈—O—CO—_{C2-C12}-alkylene-CO—O—(CH₂)₂₋₈—]ₙ—,
   where n=1 to 200;
   sequences containing siloxane groups, of the type 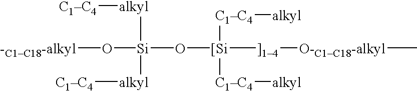
   polyester sequences containing siloxane groups, of the type —[(X)ᵣ—O—CO—(Y)ₛ—CO—O—(X)ᵣ]—,
      in which
x={(CH₂)₂₋₈—O—CO-_{C6-C14}-arylene-CO—O—(CH₂)₂₋₈—} or —{(CH₂)₂₋₈—O—CO-_{C2-C12}-alkylene-CO—O—(CH₂)₂₋₈—}; 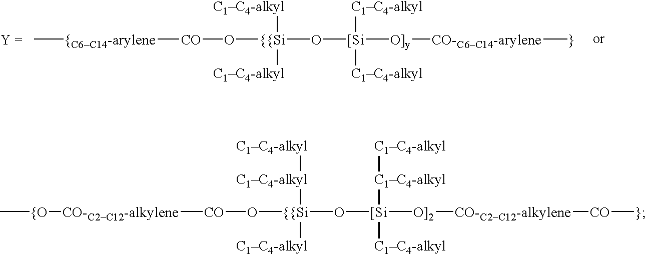
   r 1 to 70; s=1 to 70 and y=3 to 50;
   polyether sequences containing siloxane groups, of the type 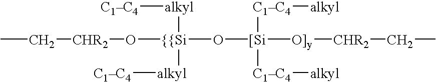
      where R₂=H; C₁-C₄-alkyl and y=3 to 50;
   sequences based on alkylene oxide adducts of melamine, of the type of 2-amino-4,6-di-_{C2-C4}-alkyleneamino-1,3,5-triazine sequences;
   phenol ether sequences based on dihydric phenols and C₂-C₈ diols, of the type of -_{C2-C8}-alkylene-O-_{C6-C18}-arylene-O-_{C2-C8}-alkylene- sequences.

The 4- to 1 000-nucleus polytriazine ethers used in the compositions of the invention can be prepared by etherifying melamine resin precondensates with C₁-C₄ alcohols, where appropriate with subsequent partial transetherification with C₄-C₁₈ alcohols, C₂-C₁₈ diols, polyhydric alcohols of the glycerol or pentaerythritol type, C₅-C₁₈ amino alcohols, polyalkylene glycols, polyesters containing terminal hydroxyl groups, siloxane polyesters, siloxane polyethers, melamine-alkylene oxide adducts and/or two-nucleus-phenol-alkylene oxide adducts and/or reaction with C₅-C₁₈ diamines and/or bisepoxides, and subsequent thermal condensation of the modified melamine resin condensates in the melt in a continuous compounder at temperatures of 140 to 220° C.

The melamine resin precondensates which are used in the preparation of the 4- to 1 000-nucleus oligotriazine ethers are preferably precondensates which as C₁-C₈ aldehyde components may comprise formaldehyde, acetaldehyde and/or trimethylolacetaldehyde and as melamine component may comprise not only melamine but also acetoguanamine and/or benzoguanamine. Particular preference is given to precondensates of melamine and formaldehyde with a melamine/formaldehyde molar ratio of 1:1.5 to 1:3.

The melamine resin polycondensates present in the compositions are preferably mixtures of meltable 4- to 300-nucleus polytriazine ethers.

The thermoinducible curing agents of the type of blocked sulphonic acid of the general formula
R₁—SO₂—O—R₂ (I)
in the compositions for producing amino resin products are preferably blocked sulphonic acids in which the substituents
R₁=unsubstituted or singly or multiply halogen-, C₁-C₄-haloalkyl-, C₁-C₁₆-alkyl-, C₁-C₄-alkoxy-, C₁-C₄-alkyl-CO—NH—, phenyl-CO—NH—, benzoyl- and/or nitro-substituted C₆-C₁₀-aryl or C₇-C₁₂-arylalkyl,
R₂=4-nitrobenzyl, pentafluorobenzyl, 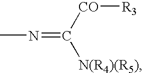
R₃=C₁-C₁₂-alkyl, C₁-C₄-haloalkyl, C₂-C₆-alkenyl, C₅-C₁₂-cycloalkyl, unsubstituted or singly or multiply halogen-, C₁-C₄-haloalkyl-, C₁-C₁₆-alkyl-, C₁-C₄-alkoxy-, C₁-C₄-alkyl-CO—NH—, phenyl-CO—NH—, benzoyl- or nitro-substituted C₆-C₁₀-aryl and/or C₇-C₁₂-arylalkyl, C₁-C₈-alkoxy, C₅-C₈-cycloalkoxy, phenoxy or H₂N—CO—NH—, —CN, C₂-C₅-alkyloyl, benzoyl, C₂-C₅-alkoxycarbonyl, phenoxycarbonyl, morpholino-, piperidino-, C₁-C₁₂-alkyl, C₁-C₄-haloalkyl, C₂-C₆-alkenyl, C₅-C₁₂-cycloalkyl, unsubstituted or singly or multiply halogen-, C₁-C₄-haloalkyl-, C₁-C₁₆-alkyl-, C₁-C₄-alkoxy-, C₁-C₄-alkyl-CO—NH—, phenyl-CO—NH—, benzoyl- and/or nitro-substituted C₆-C₁₀-aryl, C₇-C₁₂-arylalkyl, C₁-C₈-alkoxy, C₅-C₈-cycloalkoxy-, phenoxy-, or H₂N—CO—NH—,
R₄=H, C₁-C₁₂-alkyl, phenyl, C₂-C₉-alkanoyl or benzyl
R₅=H, C₁-C₁₂-alkyl or cyclohexyl,
or R₃ and R₄ or R₅ together with the atoms to which they are attached form a 5- to 8-membered ring which can be fused by 1 or 2 benzo radicals.

Examples of preferred blocked sulphonic acids are benzil monoxime tosylate, benzil monoxime p-dodecylbenzenesulphonate, 4-nitroacetophenone oxime tosylate, ethyl α-tosyloxyiminocaproate, ethyl α-cyclohexylsulphonyloxyiminophenylacetate, phenyl α-(4-chlorophenyl-sulphonyloxyimino)caproate, 4,4-dimethylbenzil monoxime tosylate, dibenzyl ketone oxime tosylate, acetone oxime p-benzoylbenzenesulphonate, α-tetralone oxime tosylate, anthraquinone monoxime tosylate, thioxanthone oxime tosylate, α-(p-toluenesulphonyloxyimino)benzyl cyanide, α-(4-nitrobenzenesulphonyloxyimino)benzyl cyanide, α-(benzenesulphonyloxyimino)-4-chlorobenzyl cyanide, α-(benzenesulphoxyimino)-2,6-dichlorobenzyl cyanide, α-(2-chlorobenzenesulphonyloxyimino)-4-methoxybenzyl cyanide, 4-chloro-α-trifluoroacetophenone oxime benzenesulphonate, fluorene oxime tosylate, α-(benzenesulphonyloxyimino)ureidocarbonylacetonitrile, α-(p-toluenesulphonyloxyimino)benzoylacetonitrile, 2,3-dihydro-1,4-naphthoquinone monoxime tosylate, acetophenone oxime tosylate, chroman oxime tosylate, 2-nitrobenzyl sulphonate, 2,6-dinitrobenzyl benzenesulphonate, 4-nitrobenzyl 9,10-dimethoxyanthracene-2-sulphonate, 2-methylsulphonyloxyimino-4-phenylbut-3-enenitrile, 4-cyclohex-1-enyl-2-methylsulphonyloxyiminobut-3-enenitrile, 4-furan-2-ylisopropylsulphonyloxyiminobut-3-enenitrile and 2-pentafluorophenylsulphonyloxyimino-4-phenylbut-3-enenitrile.

Examples of aliphatic C₄-C₁₈ carboxylic acids which may be present as thermoinducible curing agents in the formulations of the invention are butyric acid, caproic acid, palmitic acid, stearic acid and oleic acid.

Examples of aromatic C₇-C₁₈ carboxylic acids which may be present as thermoinducible curing agents in the formulations of the invention are benzoic acid, phthalic acid or naphthalenedicarboxylic acid.

Examples of alkali metal salts or ammonium salts of phosphoric acid which may be present as thermoinducible curing agents in the compositions of the invention are ammonium hydrogenphosphate, sodium polyphosphate and potassium hydrogenphosphate.

The C₁-C₁₂-alkyl esters and/or C₂-C₈-hydroxyalkyl esters of C₇-C₁₄ aromatic carboxylic acids in the compositions for producing amino resin products are preferably dibutyl phthalate, phthalic acid diglycol esters and/or trimellitic acid glycol esters.

In the compositions for producing amino resin products the salts of melamine and/or guanamines with C₁₋₁₈ aliphatic carboxylic acids are preferably melamine formate, melamine citrate, melamine maleate, melamine fumarate and/or acetoguanamine butyrate.

In the compositions for producing amino resin products the anhydrides, monoesters or monoamides of C₄-C₂₀ dicarboxylic acids that are used as thermoinducible curing agents are preferably maleic anhydride, succinic anhydride, phthalic anhydride, mono-C₁-C₁₈-alkyl maleates, maleic monoamide or maleic mono-C₁-C₁₈-alkyl amides.

Examples of mono-C₁-C₁₈-alkyl maleates are monobutyl maleate, monoethylhexyl maleate or monostearyl maleate.

Examples of the maleic mono-C₁-C₁₈-alkyl amides are maleic monoethylamide, maleic monooctylamide or maleic monostearylamide.

In the compositions for producing amino resin products the monoesters or monoamides of copolymers of ethylenically unsaturated C₄-C₂₀ dicarboxylic anhydrides and ethylenically unsaturated monomers of the C₂-C₂₀ olefin and/or C₈-C₂₀ vinylaromatic type that are used as thermoinducible curing agents are preferably monoesters or monoamides of copolymers of maleic anhydride and C₃-C₈ α-olefins of the isobutene, diisobutene and/or 4-methylpentene and/or styrene type with a maleic anhydride/C₃-C₈ α-olefin and/or styrene and/or corresponding monomer mixtures molar ratio of 1:1 to 1:5.

In the compositions for producing amino resin products the salts of C₁-C₁₂-alkylamines and/or alkanolamines with C₁-C₈ aliphatic, C₇-C₁₂ aromatic and/or alkylaromatic carboxylic acids or inorganic acids of the hydrochloric acid, sulphuric acid or phosphoric acid type are preferably ethanolammonium chloride, triethylammonium maleate, diethanolammonium phosphate and/or isopropylammonium p-toluenesulphonate.

Examples of suitable fillers which may be present in the compositions for producing amino resin products at up to 400% by mass, based on the melamine resin precondensates, are Al₂O₃, Al(OH)₃, barium sulphate, calcium carbonate, glass beads, siliceous earth, mica, quartz flour, slate flour, hollow microbeads, carbon black, talc, rock flour, wood flour, cellulose powders and/or husk meals and core meals such as peanut shell meal or olive kernel meal. Preferred fillers are phyllosilicates of the type of montmorillonite, bentonite, kaolinite, muscovite, hectorite, fluorohectorite, kanemite, revdite, grumantite, ilerite, saponite, beidelite, nontronite, stevensite, laponite, taneolite, vermiculite, halloysite, volkonskoite, magadite, rectorite, kenyaite, sauconite, boron fluorophlogopites and/or synthetic smectites.

Examples of suitable reinforcing fibres which may be present in the compositions for producing amino resin products at up to 400% by mass, based on the melamine resin precondensates, are inorganic fibres, especially glass fibres and/or carbon fibres, natural fibres, especially cellulosic fibres such as flax, jute, kenaf and wood fibres, and/or polymeric fibres, especially fibres of polyacrylonitrile, polyvinyl alcohol, polyvinyl acetate, polypropylene, polyesters and/or polyamides.

Examples of reactive polymers of the ethylene copolymer type which may be present in the compositions for producing amino resin products at up to 30% by mass, based on the melamine resin precondensates, are partially hydrolysed ethylene-vinyl acetate copolymers, ethylene-butyl acrylate-acrylic acid copolymers, ethylene-hydroxyethyl acrylate copolymers or ethylene-butyl acrylate-glycidyl methacrylate copolymers.

Examples of reactive polymers of the maleic anhydride copolymer type which may be present in the compositions for producing amino resin products at up to 30% by mass, based on the melamine resin precondensates, are C₂-C₂₀ olefin-maleic anhydride copolymers or copolymers of maleic anhydride and C₈-C₂₀ vinylaromatics.

Examples of the C₂-C₂₀ olefin components which may be present in the maleic anhydride copolymers are ethylene, propylene, but-1-ene, isobutene, diisobutene, hex-1-ene, oct-1-ene, hept-1-ene, pent-1-ene, 3-methylbut-1-ene, 4-methylpent-1-ene, methylethylpent-1-ene, ethylpent-1-ene, ethylhex-1-ene, octadec-1-ene and 5,6-dimethylnorbornene.

Examples of the C₈-C₂₀ vinylaromatic components which may be present in the maleic anhydride copolymers are styrene, α-methylstyrene, dimethylstyrene, isopropenylstyrene, p-methylstyrene and vinylbiphenyl.

The modified maleic anhydride copolymers present where appropriate in the compositions for producing amino resin products are preferably partly or fully esterified, amidated and/or imidated maleic anhydride copolymers.

Particularly suitable are modified copolymers of maleic anhydride and C₂-C₂₀ olefins and/or C₈-C₂₀ vinylaromatics having a molar ratio of 1:1 to 1:9 and molar mass weight averages of 5 000 to 500 000 which have been reacted with ammonia, C₁-C₁₈-monoalkylamines, C₆-C₁₈ aromatic monoamines, C₂-C₁₈ monoamino alcohols, monoaminated poly(C₂-C₄-alkylene) oxides with a molar mass of 400 to 3 000 and/or monoetherified poly(C₂-C₄-alkylene) oxides with a molar mass of 100 to 10 000, where the molar ratio of anhydride groups of copolymer/ammonia, amino groups of C₁-C₁₈-monoalkylamines, C₈-C₁₈ aromatic monoamines, C₂-C₁₈ monoamino alcohols and/or monoaminated poly(C₂-C₄-alkylene) oxide and/or hydroxyl groups of poly(C₂-C₄-alkylene)oxide is 1:1 to 20:1.

Examples of reactive polymers of the poly(meth)acrylate type which may be present in the compositions for producing amino resin products at up to 30% by mass, based on the melamine resin precondensates, are copolymers based on functional unsaturated (meth)acrylate monomers such as acrylic acid, hydroxyethyl acrylate, glycidyl acrylate, methacrylic acid, hydroxybutyl methacrylate or glycidyl methacrylate and non-functional unsaturated (meth)acrylate monomers such as ethyl acrylate, butyl acrylate, ethylhexyl acrylate, methyl methacrylate, ethyl acrylate and/or butyl methacrylate and/or C₈-C₂₀ vinylaromatics. Preference is given to copolymers based on methacrylic acid, hydroxyethyl acrylate, methyl methacrylate and styrene.

Examples of reactive polymers of the polyamide type which may be present in the compositions for producing amino resin products at up to 30% by mass, based on the melamine resin precondensates, are polyamide 6, polyamine 6,6, polyamide 11, polyamide 12, polyaminoamides formed from polycarboxylic acids and polyalkyleneamines, and the corresponding methoxylated polyamides.

Examples of reactive polymers of the polyester type which may be present in the compositions for producing amino resin products at up to 30% by mass, based on the melamine resin precondensates, are polyesters having molar masses of 2 000 to 15 000, formed from saturated dicarboxylic acids such as phthalic acid, isophthalic acid, adipic acid and/or succinic acid, unsaturated dicarboxylic acids such as maleic acid, fumaric acid and/or itaconic acid and diols such as ethylene glycol, butanediol, neopentylglycol and/or hexanediol. Preference is given to branched polyesters based on neopentylglycol, trimethylolpropane, isophthalic acid and azelaic acid.

Examples of reactive polymers of the polyurethane type that may be present in the compositions for producing amino resin products at up to 30% by mass, based on the melamine resin precondensates, are uncrosslinked polyurethanes based on tolylene diisocyanate, diphenylmethyl diisocyanate, butane diisocyanate and/or hexane diisocyanate as diisocyanate components and butanediol, hexanediol and/or polyalkylene glycols as diol components with molar masses of 2 000 to 30 000.

Examples of suitable stabilizers and UV absorbers which may be present in the compositions for producing amino resin products at up to 2% by mass, based on the melamine resin precondensates, are piperidine derivatives, benzophenone derivatives, benzotriazole derivatives, triazine derivatives and/or benzofuranone derivatives.

Examples of suitable auxiliaries which may be present in the compositions for producing amino resin products at up to 4% by mass, based on the melamine resin precondensates, are processing auxiliaries such as calcium stearate, magnesium stearate and/or waxes.

Also in accordance with the invention is a process for producing products from the above-described compositions for producing amino resin products, produced by melt processing, wherein the compositions are melted in continuous compounders at melt temperatures of 105 to 220° C. and residence times of 2 to 12 min and, with curing of the meltable melamine resin polycondensates, by customary processing methods for thermoplastic polymers,
A) are applied as a melt to a smoothing unit and taken off as sheet via conveyor belts and cut or are applied to and sealed on sheet webs comprising metal foils, polymeric films, paper webs or textile webs and are taken off as multi-component composites and finished, or
B) are discharged through a profile die and taken off as profile or sheet material, cut and finished, or
C) are discharged through an annular die, taken off as pipe, with injection of air, cut and finished, or
D) following the introduction of blowing agents, are discharged through a slot die and taken off as foamed sheet material, or
E) are discharged through the slot die of a pipe sheathing unit and applied in liquid melt form to, and sealed on, the rotating pipe, or
F) in injection moulding machines, preferably with three-section screws with a screw length of 18 to 24 D, at high injection rates and at mould temperatures of 5 to 70° C., are processed to injection mouldings, or
G) in melt spinning units are extruded by means of the melt pump through the capillary die into the blowing shaft and taken off as filaments or separated off by the melt-blown process as fibres, or discharged as a melt by the rotational spinning process into a shear field chamber using organic dispersants, to form fibrids, and processed further in downstream installations, or
H) are metered by the resin infusion process into an open mould with the semi-finished fibre product and shaped to laminates by the vacuum bag technology, or
I) are injected by the resin injection process into a lockable mould in which there are preforms of textile material, and are shaped to components and cured, or
K) are used for the melt impregnation of component blanks produced by the filament winding process, braiding process or pultrusion process,
   and for full curing where appropriate the products are subjected to a thermal aftertreatment at temperatures of 180 to 220° C. and residence times of 30 to 120 min.

For the production of products from the compositions of the invention comprising fillers, reinforcing fibres, other reactive polymers, stabilizers, UV absorbers and/or auxiliaries it is possible to use compositions in which these components are already present, or the components are added during the processing of the compositions.

Suitable continuous compounders for the melting of the compositions of the invention are extruders having short-compression screws or three-section screws with L/D=20-40. Preference is given to 5-section screws with an intake zone, compression zone, shearing zone, decompression zone and homogenizing zone. Screws with depths of cut of 1:2.5 to 1:3.5 are suitable with preference. The interposition of static mixers or melt pumps between barrel and die is particularly favourable.

Favourable melt temperatures for the melted compositions in the case of processing by the smoothing unit technology to form sheets or coatings or in the production of sheets, profiles or pipes by extrusion from a profile die are in the range from 110 to 150° C.

In the case of the production of foamed sheet material by discharge through a slot die it is possible to use compositions which comprise gas-evolving blowing agents such as sodium hydrogencarbonate, azodicarboxamide, citric acid/bicarbonate blowing systems and/or cyanuric trihydrazide, or volatile hydrocarbons such as pentane, isopentane, propane and/or isobutane, or gases such as nitrogen, argon and/or carbon dioxide, are introduced into the melt prior to discharge. Suitable die temperatures for the discharge of the melt containing blowing agents are 110 to 175° C. Preferred foam densities of the foams formed from the compositions of the invention are in the range from 10 to 500 kg/m².

For the extrusion coating of metal pipes it is necessary for the temperatures of the melts of the compositions to be 135° C. to 220° C. and for the pipe material to be preheated at 100 to 160° C.

In the production of injection-moulded products from the compositions of the invention it is preferred to use injection moulding machines having injection units which possess three-section screws with a screw length of 18 to 24 D. The injection rate when producing the mouldings produced by injection moulding should be set as high as possible in order to eliminate sink marks and poor seams.

In the production of fibre products from the compositions of the invention it is preferred, for the uniform metering of the melt of the compositions melted in the plastifying extruder via the melt distributor to the capillary die, to use biphenyl-heated melt pumps for the melts heated at 120-240° C.

The production of filament yarns from the compositions of the invention can take place in short-spinning units by means of filament take-off with the aid of high-speed godets and further processing in downstream installations comprising aftercure chamber, drawing equipment and winders.

Fibres or non-wovens as products formed from the compositions of the invention can likewise be produced by the melt-blown process, by applying a stream of air heated to high temperatures around the apertures in the capillary die during the extrusion of the filaments from the capillary die into the blowing shaft. The stream of air stretches the melted filament and at the same time divides it into a large number of small individual fibres with diameters of 0.5 to 12 μm. Further processing of the fibres deposited on the screen conveyor belt, to form non-wovens, can be accomplished by applying thermobonding or needling operations in order to achieve the required strength and dimensional stability.

Fibre-reinforced plastics by the resin infusion process can be produced by impregnating the semi-finished fibre products by means of the melt of the composition of the invention that is under ambient pressure, which is pressed into the evacuated vacuum bag, with the use of an open mould.

Sheetlike components or components of complex shape by the resin injection process are produced by inserting preforms made of non-impregnated textiles into a lockable mould, injecting the melt of the composition of the invention, and carrying out curing.

Rotationally symmetric components by the filament winding process, complex components by the circular braiding technique or profiles by the pultrusion technique can be produced by impregnating the fibre blanks in the form of pipes, fittings, containers or profiles with the melt of the composition of the invention.

The invention is illustrated by the following examples:

### EXAMPLE 1

The meltable melamine resin polycondensate used in the composition is a polytriazine ether formed from melamine and formaldehyde with a melamine/formaldehyde ratio of 1:3. The methylol groups have been predominantly etherified by methanol, so that the methoxy group content of the resin is 20% by mass. The molar mass of the polytriazine ether is around 2 000 g/mol.

1% by mass of maleic acid, based on the melamine resin polycondensate, is added as thermoinducible curing agent to the meltable melamine resin polycondensate, and the progress of curing of the composition is characterized by means of dynamic mechanical analysis. Analyses were carried out on an RDS instrument from the company Rheometric Scientific. The compositions were heated from 60° C. to 300° C. at a rate of 10 K/min and the progress of the viscosity was determined. As the onset, the temperature was determined at which a sharp increase in viscosity is observed (FIG. 1).

The onset temperature of the composition is 135° C. In the comparative experiment without thermoinducible curing agent the onset temperature is 200° C.

### EXAMPLES 2 TO 9

Experiment procedure analogous to Example 1; instead of maleic anhydride as thermoinducible curing agent, the curing agents indicated in Table 1 were used:

| | | Onset temperature |
|---|---|---|
| Example | Curing agent | (° C.) |
| 2 | phthalic acid | 155 |
| 3 | maleic anhydride | 110 |
| 4 | phthalic anhydride | 126 |
| 5 | monobutyl maleate | 130 |
| 6 | maleic monoamide | 140 |
| 7 | melamine maleate | 145 |
| 8 | p-toluenesulphonic acid | 200 |
| 9 | none | 200 |

In comparative experiment 8 p-toluenesulphonic acid, as a strong acid, was used as thermoinducible curing agent. The composition with the strong acid gives an onset temperature which is higher by 45 to 90° C. in relation to the compositions of the invention, or the same onset temperature as in compositions without thermoinducible curing agents (comparative experiment 9).

### EXAMPLE 10

The melamine resin used is a melamine-formaldehyde precondensate based on 2,4,6-trismethoxymethylamino-1,3,5-triazine which has been transetherified with an ethylene glycol diether of bisphenol A (Simulsol BPLE, Seppic S.A., France). The molar mass determined by GPC is 1 800, the amount of unreacted Simulsol BPLE by HPLC analysis (solution in THF, UV detection with external standard) is 14% by mass. The fraction of —OCH₃ groups in the transetherified melamine resin (determination by GC analysis following cleavage of the polytriazine ether with mineral acid) is 14.5% by mass. The viscosity at 140° C. is 800 Pas.

The transetherification of the melamine-formaldehyde precondensate based on 2,4,6-trismethoxymethylamino-1,3,5-triazine and further condensation takes place at 220° C. in a GL 27 D44 laboratory extruder with vacuum devolatilization (Leistritz) with a temperature profile of 100° C./130° C./130° C./200° C./200° C./200° C./200° C./200° C./200° C./100° C./100° C. and an average residence time of 2.5 min. The extruder speed is 150 min⁻¹. Metered gravimetrically into the intake zone of the extruder by means of side-stream metering are 2,4,6-trismethoxymethylamino-1,3,5-triazine at 1.38 kg/h and the ethylene glycol diether of bisphenol A at 1.13 kg/h. The strand of the polytriazine ether that emerges from the extruder is chopped in a pelletizer.

The transetherified resin is compounded with 1% by mass of maleic acid and the progress of curing this compound is determined in analogy to Example 1 by means of Dynamic Mechanical Analysis. The onset temperature in this example is 125° C.

### EXAMPLE 11-14

Experimental procedure analogous to Example 10, using the curing agents indicated in Table 2:

| | | Onset temperature |
|---|---|---|
| Example | Curing agent | (° C.) |
| 10 | maleic acid | 125 |
| 11 | maleic anhydride | 116 |
| 12 | phthalic anhydride | 121 |
| 13 | p-toluenesulphonic acid | 170 |
| 14 | none | 180 |

FIG. 1

Progress of curing in the compositions according to Example 1 without thermoinducible curing agent and with 1% by mass of maleic acid, based on the melamine resin polycondensate, as thermoinducible curing agent

[image]

1. A composition for producing amino resin products by melt processing, said composition comprising:
A) from 95 to 99.9% by mass of solvent-free meltable polycondensates of melamine resins having molar masses of 300 to 300 000, the melamine resin polycondensates being mixtures of meltable 4- to 1000-nucleus polytriazine ethers,
B) from 0.1 to 5% by mass of weak acids as thermoinducible curing agents, composed of
B1) acid formers of the type of blocked sulphonic acid of the general formula (I)
R₁—SO₂—O—R₂ (I)
R₁=unsubstituted or substituted aryl or biphenyl
R₂=4-nitrobenzyl, pentafluorobenzyl or 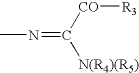
substituents
where
R₃=non-substituted or substituted alkyl or aryl,
R₄=H, C₁-C₁₂-alkyl, phenyl, C₂-C₉-alkanoyl or benzyl,
R₅=H, C₁-C₁₂-alkyl or cyclohexyl,
or R₃ and R₄ or R₅ together with the atoms to which they are attached form a 5- to 8-membered ring which can be fused by 1 or 2 benzo radicals,
B2) C₄-C₁₈ aliphatic and/or C₇-C₁₈ aromatic carboxylic acids,
B3) alkali metal salts or ammonium salts of phosphoric acid,
B4) C₁-C₁₂-alkyl esters or C₂-C₈-hydroxyalkyl esters of C₇-C₁₄ aromatic carboxylic acids or inorganic acids,
B5) salts of melamine or guanamines with C₁₋₁₈ aliphatic carboxylic acids,
B6) anhydrides, monoesters or monoamides of C₄-C₂₀ dicarboxylic acids,
B7) monoesters or monoamides of copolymers of ethylenically unsaturated C₄-C₂₀ dicarboxylic anhydrides and ethylenically unsaturated monomers of the type of C₂-C₂₀ olefins and/or C₈-C₂₀ vinylaromatics, and/or
B8) salts of C₁-C₁₂-alkylamines and/or alkanolamines with C₁-C₁₈ aliphatic, C₇-C₁₄ aromatic or alkylaromatic carboxylic acids and also inorganic acids of the type of hydrochloric acid, sulphuric acid or phosphoric acid, and
C) if desired, up to 400% by mass of fillers and/or reinforcing fibres, up to 30% by mass of other reactive polymers of the ethylene copolymer, maleic anhydride copolymer, modified maleic anhydride copolymer, poly(meth)acrylate, polyamide, polyester and/or polyurethane type, and up to 4% by mass, based in each case on the melamine resin polycondensates, of stabilizers, UV absorbers and/or auxiliaries.

2. The composition according to claim 1, wherein the polytriazine ethers the triazine segments 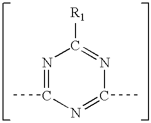
R₁=—NH₂, —NH—CHR₂—O—R₃, —NH—CHR₂—O—R₄—OH, —CH₃, —C₃H₇, —C₆H₅, —OH, phthalimido-,
succinimido-, —NH—CO-_{C5-C18}-alkyl, —NH—C₅-C₁₈-alkylene-OH, —NH—CHR₂—O—C₅-C₁₈-alkylene-NH₂, —NH—C₅-C₁₈-alkylene-NH₂, —NH—CHR₂—O—R₄—O—CHR₂—NH—, —NH—CHR₂—NH—, —NH—CHR₂—O—C₅-C₁₈-alkylene-NH—, —NH—C₅-C₁₈-alkylene-NH—, —NH—CHR₂—O—CHR₂—NH—,
R₂=H, C₁-C₇-alkyl;
R₃=C₁-C₁₈-alkyl, H;
R₄=C₂-C₁₈-alkylene, —CH(CH₃)—CH₂—O-_{C2-C12}-alkylene-O—CH₂CH(CH₃)—, —CH(CH₃)—CH₂—O-_{C2-C12}-arylene-O—CH₂—CH(CH₃)—, —[CH₂—CH₂—O—CH₂—CH₂]ₙ—, —[CH₂—CH(CH₃)—O—CH₂—CH(CH₃)]ₙ—, —[—O—CH₂—CH₂—CH₂—CH₂—]ₙ—, —[(CH₂)₂₋₈—O—CO-_{C6-C14}-arylene-CO—O—(CH₂)₂₋₈—]ₙ—, —[(CH₂)₂₋₈—O—CO-_{C2-C12}-alkylene-CO—O—(CH₂)₂₋₈—]ₙ—,
where n=1 to 200;
sequences containing siloxane groups, of the type 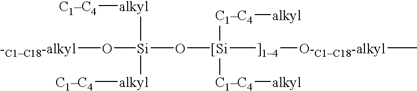
polyester sequences containing siloxane groups, of the type —[(X)ᵣ—O—CO—(Y)ₛ—CO—O—(X)ᵣ]—,
in which
x={(CH₂)₂₋₈—O—CO-_{C6-C14}-arylene-CO—O—(CH₂)₂₋₈—} or —{(CH₂)₂₋₈—O—CO-_{C2-C12}-alkylene-CO—O—(CH₂)₂₋₈—}; 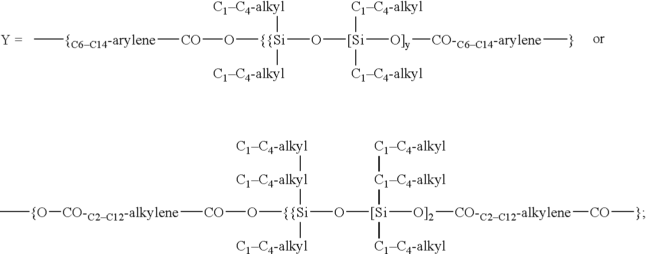
r=1 to 70; s=Ito 70 and y=3 to 50;
polyether sequences containing siloxane groups, of the type 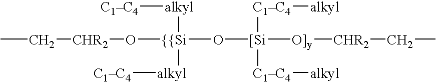
where R₂=H; C₁-C₄-alkyl and y=3 to 50;
sequences based on alkylene oxide adducts of melamine, of the type of 2-amino-4,6-d₁-C₂-C₄-alkyleneamino-1,3,5-triazine sequences;
phenol ether sequences based on dihydric phenols and C₂-C₈ diols, of the type of
-_{C2-C8}-alkylene-O-_{C6-C18}-arylene-O-_{C2-C8}-alkylene- sequences;
are linked by bridge members —NH—CHR₂—NH— or —NH—CHR₂—O—R₄—O—CHR₂—NH— and —NH—CHR₂—NH— and also, where appropriate, —NH—CHR₂—O—CHR₂—NH—, —NH—CHR₂—O—C₅-C₁₈-alkylene-NH— and/or —NH—C₅-C₁₈-alkylene-NH— to form 4- to 1 000-nucleus polytriazine ethers with a linear and/or branched structure,
in the polytriazine ethers the molar ratio of the substituents R₃:R₄=20:1 to 1:20, the proportion of the linkages of the triazine segments through bridge members —NH—CHR₃—O—R₄—O—CHR₃—NH— being from 5 to 95 mol %, and it being possible for the polytriazine ethers to contain up to 20% by mass of diols of the type HO—R₄—OH.

3. The composition according to claim 1, wherein the melamine resin polycondensates are mixtures of meltable 4- to 300-nucleus polytriazine ethers.

4. The composition according to claim 1, wherein the thermoinducible curing agents of the type of blocked sulphonic acid of the general formula
R₁—SO₂—O—R₂ (I)
are blocked sulphonic acids in which the substituents
R₁=unsubstituted or singly or multiply halogen-, C₁-C₄-haloalkyl-, C₁-C₁₆-alkyl-, C₁-C₄-alkoxy-, C₁-C₄-alkyl-CO—NH—, phenyl-CO—NH—, benzoyl- and/or nitro-substituted C₆-C₁₀-aryl or C₇-C₁₂-arylalkyl,
R₂=4-nitrobenzyl, pentafluorobenzyl, 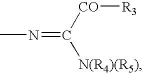
R₃=C₁-C₁₂-alkyl, C₁-C₄-haloalkyl, C₂-C₆-alkenyl, C₅-C₁₂-cycloalkyl, unsubstituted or singly or multiply halogen-, C₁-C₄-haloalkyl-, C₁-C₁₆-alkyl-, C₁-C₄-alkoxy-, C₁-C₄-alkyl-CO—NH—, phenyl-CO—NH—, benzoyl- or nitro-substituted C₆-C₁₀-aryl and/or C₇-C₁₂-arylalkyl, C₁-C₈-alkoxy, C₅-C₈-cycloalkoxy, phenoxy or H₂N—CO—NH—, —CN, C₂-C₅-alkyloyl, benzoyl, C₂-C₅-alkoxycarbonyl, phenoxycarbonyl, morpholino-, piperidino-, C_{1-C}₁₂-alkyl, C₁-C₄-haloalkyl, C₂-C₆-alkenyl, C₅-C₁₂-cycloalkyl, unsubstituted or singly or multiply halogen-, C₁-C₄-haloalkyl-, C₁-C₁₆-alkyl-, C₁-C₄-alkoxy-, C₁-C₄-alkyl-CO—NH—, phenyl-CO—NH—, benzoyl- and/or nitro-substituted C₆-C₁₀-aryl, C₇-C₁₂-arylalkyl, C₁-C₈-alkoxy, C₅-C₈-cycloalkoxy-, phenoxy-, or H₂N—CO—NH—,
R₄=H, C₁-C₁₂-alkyl, phenyl, C₂-C₉-alkanoyl or benzyl
R₅=H, C₁-C₁₂-alkyl or cyclohexyl,
or R₃ and R₄ or R₅ together with the atoms to which they are attached form a 5- to 8-membered ring which can be fused by 1 or 2 benzo radicals.

5. The composition according to claim 1, wherein the C₁-C₁₂-alkyl esters and/or C₂-C₈-hydroxyalkyl esters of C₇-C₁₄ aromatic carboxylic acids are dibutyl phthalate, phthalic acid diglycol esters and/or trimellitic acid glycol esters.

6. The composition according to claim 1, wherein the salts of melamine and/or guanamines with C₁-C₁₈ aliphatic carboxylic acids are melamine formate, melamine citrate, melamine maleate, melamine fumarate and/or acetoguanamine butyrate.

7. The composition according to claim 1, wherein the anhydrides, monoesters or monoamides of C₄-C₂₀ dicarboxylic acids are maleic anhydride, succinic anhydride, phthalic anhydride, mono-C₁-C₁₈-alkyl maleates, maleic monoamide or maleic mono-C₁-C₁₈-alkylamides.

8. The composition according to claim 1, wherein the monoesters or monoamides of copolymers of ethylenically unsaturated C₄-C₂₀ dicarboxylic anhydrides and ethylenically unsaturated monomers of the type of C₂-C₂₀ olefins and/or C₈-C₂₀ vinylaromatics are monoesters or monoamides of copolymers of maleic anhydride and C₃-C₈ α-olefins of the isobutene, diisobutene and/or 4-methylpentene and/or styrene type with a maleic anhydride/C₃-C₈ α-olefin and/or styrene and/or corresponding monomer mixtures molar ratio of 1:1 to 1:5.

9. The composition according to claim 1, wherein the salts of C₁-C₁₂-alkylamines and/or alkanolamines with C₁-C₁₈ aliphatic, C₇-C₁₄ aromatic and/or alkylaromatic carboxylic acids or inorganic acids of the hydrochloric acid, sulphuric acid or phosphoric acid type are ethanolammonium chloride, triethylammonium maleate,
diethanolammonium phosphate and/or isopropylammonium p-toluenesulphonate.

10. A process for producing products from the composition according to claim 1, produced by melt processing, wherein the composition is melted in continuous compounders at melt temperatures of 105 to 220° C. and residence times of 2 to 12 min and, with curing of the meltable melamine resin polycondensates, by customary processing methods for thermoplastic polymers,
A) is applied as a melt to a smoothing unit and taken off as sheet via conveyor belts and cut or are applied to and sealed on sheet webs comprising metal foils, polymeric films, paper webs or textile webs and are taken off as multi-component composites and finished, or
B) is discharged through a profile die and taken off as profile or sheet material, cut and finished, or
C) is discharged through an annular die, taken off as pipe, with injection of air, cut and finished, or
D) following the introduction of blowing agents, is discharged through a slot die and taken off as foamed sheet material, or
E) is discharged through the slot die of a pipe sheathing unit and applied in liquid melt form to, and sealed on, the rotating pipe, or
F) in injection moulding machines, preferably with three-section screws with a screw length of 18 to 24 D, at high injection rates and at mould temperatures of 5 to 70° C., is processed to injection mouldings, or
G) in melt spinning units is extruded by means of the melt pump through the capillary die into the blowing shaft and taken off as filaments or separated off by the melt-blown process as fibres, or discharged as a melt by the rotational spinning process into a shear field chamber using organic dispersants, to form fibrids, and processed further in downstream installations, or
H) is metered by the resin infusion process into an open mould with the semi-finished fibre product and shaped to laminates by the vacuum bag technology, or
I) is injected by the resin injection process into a lockable mould in which there are preforms of textile material, and are shaped to components and cured, or
K) is used for the melt impregnation of component blanks produced by the filament winding process, braiding process or pultrusion process, and for full curing where appropriate the products are subjected to a thermal aftertreatment at temperatures of 180 to 220° C. and residence times of 30 to 120 min.

11. A process for producing products from the composition according to claim 2, produced by melt processing, wherein the composition is melted in continuous compounders at melt temperatures of 105 to 220° C. and residence times of 2 to 12 min and, with curing of the meltable melamine resin polycondensates, by customary processing methods for thermoplastic polymers,
A) is applied as a melt to a smoothing unit and taken off as sheet via conveyor belts and cut or are applied to and sealed on sheet webs comprising metal foils, polymeric films, paper webs or textile webs and are taken off as multi-component composites and finished, or
B) is discharged through a profile die and taken off as profile or sheet material, cut and finished, or
C) is discharged through an annular die, taken off as pipe, with injection of air, cut and finished, or
D) following the introduction of blowing agents, is discharged through a slot die and taken off as foamed sheet material, or
E) is discharged through the slot die of a pipe sheathing unit and applied in liquid melt form to, and sealed on, the rotating pipe, or
F) in injection moulding machines, preferably with three-section screws with a screw length of 18 to 24 D, at high injection rates and at mould temperatures of 5 to 70° C., is processed to injection mouldings, or
G) in melt spinning units is extruded by means of the melt pump through the capillary die into the blowing shaft and taken off as filaments or separated off by the melt-blown process as fibres, or discharged as a melt by the rotational spinning process into a shear field chamber using organic dispersants, to form fibrids, and processed further in downstream installations, or
H) is metered by the resin infusion process into an open mould with the semi-finished fibre product and shaped to laminates by the vacuum bag technology, or
I) is injected by the resin injection process into a lockable mould in which there are preforms of textile material, and are shaped to components and cured, or
K) is used for the melt impregnation of component blanks produced by the filament winding process, braiding process or pultrusion process,
and for full curing where appropriate the products are subjected to a thermal aftertreatment at temperatures of 180 to 220° C. and residence times of 30 to 120 min.

12. A process for producing products from the composition according to claim 3, produced by melt processing, wherein the composition is melted in continuous compounders at melt temperatures of 105 to 220° C. and residence times of 2 to 12 min and, with curing of the meltable melamine resin polycondensates, by customary processing methods for thermoplastic polymers,
A) is applied as a melt to a smoothing unit and taken off as sheet via conveyor belts and cut or are applied to and sealed on sheet webs comprising metal foils, polymeric films, paper webs or textile webs and are taken off as multi-component composites and finished, or
B) is discharged through a profile die and taken off as profile or sheet material, cut and finished, or
C) is discharged through an annular die, taken off as pipe, with injection of air, cut and finished, or
D) following the introduction of blowing agents, is discharged through a slot die and taken off as foamed sheet material, or
E) is discharged through the slot die of a pipe sheathing unit and applied in liquid melt form to, and sealed on, the rotating pipe, or
F) in injection moulding machines, preferably with three-section screws with a screw length of 18 to 24 D, at high injection rates and at mould temperatures of 5 to 70° C., is processed to injection mouldings, or
G) in melt spinning units is extruded by means of the melt pump through the capillary die into the blowing shaft and taken off as filaments or separated off by the melt-blown process as fibres, or discharged as a melt by the rotational spinning process into a shear field chamber using organic dispersants, to form fibrids, and processed further in downstream installations, or
H) is metered by the resin infusion process into an open mould with the semi-finished fibre product and shaped to laminates by the vacuum bag technology, or
I) is injected by the resin injection process into a lockable mould in which there are preforms of textile material, and are shaped to components and cured, or
K) is used for the melt impregnation of component blanks produced by the filament winding process, braiding process or pultrusion process,
and for full curing where appropriate the products are subjected to a thermal aftertreatment at temperatures of 180 to 220° C. and residence times of 30 to 120 min.

13. A process for producing products from the composition according to claim 4, produced by melt processing, wherein the composition is melted in continuous compounders at melt temperatures of 105 to 220° C. and residence times of 2 to 12 min and, with curing of the meltable melamine resin polycondensates, by customary processing methods for thermoplastic polymers,
A) is applied as a melt to a smoothing unit and taken off as sheet via conveyor belts and cut or are applied to and sealed on sheet webs comprising metal foils, polymeric films, paper webs or textile webs and are taken off as multi-component composites and finished, or
B) is discharged through a profile die and taken off as profile or sheet material, cut and finished, or
C) is discharged through an annular die, taken off as pipe, with injection of air, cut and finished, or
D) following the introduction of blowing agents, is discharged through a slot die and taken off as foamed sheet material, or
E) is discharged through the slot die of a pipe sheathing unit and applied in liquid melt form to, and sealed on, the rotating pipe, or
F) in injection moulding machines, preferably with three-section screws with a screw length of 18 to 24 D, at high injection rates and at mould temperatures of 5 to 70° C., is processed to injection mouldings, or
G) in melt spinning units is extruded by means of the melt pump through the capillary die into the blowing shaft and taken off as filaments or separated off by the melt-blown process as fibres, or discharged as a melt by the rotational spinning process into a shear field chamber using organic dispersants, to form fibrids, and processed further in downstream installations, or
H) is metered by the resin infusion process into an open mould with the semi-finished fibre product and shaped to laminates by the vacuum bag technology, or
I) is injected by the resin injection process into a lockable mould in which there are preforms of textile material, and are shaped to components and cured, or
K) is used for the melt impregnation of component blanks produced by the filament winding process, braiding process or pultrusion process, and for full curing where appropriate the products are subjected to a thermal aftertreatment at temperatures of 180 to 220° C. and residence times of 30 to 120 min.

14. A process for producing products from the composition according to claim 5, produced by melt processing, wherein the composition is melted in continuous compounders at melt temperatures of 105 to 220° C. and residence times of 2 to 12 min and, with curing of the meltable melamine resin polycondensates, by customary processing methods for thermoplastic polymers,
A) is applied as a melt to a smoothing unit and taken off as sheet via conveyor belts and cut or are applied to and sealed on sheet webs comprising metal foils, polymeric films, paper webs or textile webs and are taken off as multi-component composites and finished, or
B) is discharged through a profile die and taken off as profile or sheet material, cut and finished, or
C) is discharged through an annular die, taken off as pipe, with injection of air, cut and finished, or
D) following the introduction of blowing agents, is discharged through a slot die and taken off as foamed sheet material, or
E) is discharged through the slot die of a pipe sheathing unit and applied in liquid melt form to, and sealed on, the rotating pipe, or
F) in injection moulding machines, preferably with three-section screws with a screw length of 18 to 24 D, at high injection rates and at mould temperatures of 5 to 70° C., is processed to injection mouldings, or
G) in melt spinning units is extruded by means of the melt pump through the capillary die into the blowing shaft and taken off as filaments or separated off by the melt-blown process as fibres, or discharged as a melt by the rotational spinning process into a shear field chamber using organic dispersants, to form fibrids, and processed further in downstream installations, or
H) is metered by the resin infusion process into an open mould with the semi-finished fibre product and shaped to laminates by the vacuum bag technology, or
I) is injected by the resin injection process into a lockable mould in which there are preforms of textile material, and are shaped to components and cured, or
K) is used for the melt impregnation of component blanks produced by the filament winding process, braiding process or pultrusion process,
and for full curing where appropriate the products are subjected to a thermal aftertreatment at temperatures of 180 to 220° C. and residence times of 30 to 120 min.

15. A process for producing products from the composition according to claim 6, produced by melt processing, wherein the composition is melted in continuous compounders at melt temperatures of 105 to 220° C. and residence times of 2 to 12 min and, with curing of the meltable melamine resin polycondensates, by customary processing methods for thermoplastic polymers,
A) is applied as a melt to a smoothing unit and taken off as sheet via conveyor belts and cut or are applied to and sealed on sheet webs comprising metal foils, polymeric films, paper webs or textile webs and are taken off as multi-component composites and finished, or
B) is discharged through a profile die and taken off as profile or sheet material, cut and finished, or
C) is discharged through an annular die, taken off as pipe, with injection of air, cut and finished, or
D) following the introduction of blowing agents, is discharged through a slot die and taken off as foamed sheet material, or
E) is discharged through the slot die of a pipe sheathing unit and applied in liquid melt form to, and sealed on, the rotating pipe, or
F) in injection moulding machines, preferably with three-section screws with a screw length of 18 to 24 D, at high injection rates and at mould temperatures of 5 to 70° C., is processed to injection mouldings, or
G) in melt spinning units is extruded by means of the melt pump through the capillary die into the blowing shaft and taken off as filaments or separated off by the melt-blown process as fibres, or discharged as a melt by the rotational spinning process into a shear field chamber using organic dispersants, to form fibrids, and processed further in downstream installations, or
H) is metered by the resin infusion process into an open mould with the semi-finished fibre product and shaped to laminates by the vacuum bag technology, or
I) is injected by the resin injection process into a lockable mould in which there are preforms of textile material, and are shaped to components and cured, or
K) is used for the melt impregnation of component blanks produced by the filament winding process, braiding process or pultrusion process,
and for full curing where appropriate the products are subjected to a thermal aftertreatment at temperatures of 180 to 220° C. and residence times of 30 to 120 min.

16. A process for producing products from the composition according to claim 7, produced by melt processing, wherein the composition is melted in continuous compounders at melt temperatures of 105 to 220° C. and residence times of 2 to 12 min and, with curing of the meltable melamine resin polycondensates, by customary processing methods for thermoplastic polymers,
A) is applied as a melt to a smoothing unit and taken off as sheet via conveyor belts and cut or are applied to and sealed on sheet webs comprising metal foils, polymeric films, paper webs or textile webs and are taken off as multi-component composites and finished, or
B) is discharged through a profile die and taken off as profile or sheet material, cut and finished, or
C) is discharged through an annular die, taken off as pipe, with injection of air, cut and finished, or
D) following the introduction of blowing agents, is discharged through a slot die and taken off as foamed sheet material, or
E) is discharged through the slot die of a pipe sheathing unit and applied in liquid melt form to, and sealed on, the rotating pipe, or
F) in injection moulding machines, preferably with three-section screws with a screw length of 18 to 24 D, at high injection rates and at mould temperatures of 5 to 70° C., is processed to injection mouldings, or
G) in melt spinning units is extruded by means of the melt pump through the capillary die into the blowing shaft and taken off as filaments or separated off by the melt-blown process as fibres, or discharged as a melt by the rotational spinning process into a shear field chamber using organic dispersants, to form fibrids, and processed further in downstream installations, or
H) is metered by the resin infusion process into an open mould with the semi-finished fibre product and shaped to laminates by the vacuum bag technology, or
I) is injected by the resin injection process into a lockable mould in which there are preforms of textile material, and are shaped to components and cured, or
K) is used for the melt impregnation of component blanks produced by the filament winding process, braiding process or pultrusion process,
and for full curing where appropriate the products are subjected to a thermal aftertreatment at temperatures of 180 to 220° C. and residence times of 30 to 120 min.

17. A process for producing products from the composition according to claim 8, produced by melt processing, wherein the composition is melted in continuous compounders at melt temperatures of 105 to 220° C. and residence times of 2 to 12 min and, with curing of the meltable melamine resin polycondensates, by customary processing methods for thermoplastic polymers,
A) is applied as a melt to a smoothing unit and taken off as sheet via conveyor belts and cut or are applied to and sealed on sheet webs comprising metal foils, polymeric films, paper webs or textile webs and are taken off as multi-component composites and finished, or
B) is discharged through a profile die and taken off as profile or sheet material, cut and finished, or
C) is discharged through an annular die, taken off as pipe, with injection of air, cut and finished, or
D) following the introduction of blowing agents, is discharged through a slot die and taken off as foamed sheet material, or
E) is discharged through the slot die of a pipe sheathing unit and applied in liquid melt form to, and sealed on, the rotating pipe, or
F) in injection moulding machines, preferably with three-section screws with a screw length of 18 to 24 D, at high injection rates and at mould temperatures of 5 to 70° C., is processed to injection mouldings, or
G) in melt spinning units is extruded by means of the melt pump through the capillary die into the blowing shaft and taken off as filaments or separated off by the melt-blown process as fibres, or discharged as a melt by the rotational spinning process into a shear field chamber using organic dispersants, to form fibrids, and processed further in downstream installations, or
H) is metered by the resin infusion process into an open mould with the semi-finished fibre product and shaped to laminates by the vacuum bag technology, or
I) is injected by the resin injection process into a lockable mould in which there are preforms of textile material, and are shaped to components and cured, or
K) is used for the melt impregnation of component blanks produced by the filament winding process, braiding process or pultrusion process,
and for full curing where appropriate the products are subjected to a thermal aftertreatment at temperatures of 180 to 220° C. and residence times of 30 to 120 min.

18. A process for producing products from the composition according to claim 9, produced by melt processing, wherein the composition is melted in continuous compounders at melt temperatures of 105 to 220° C. and residence times of 2 to 12 min and, with curing of the meltable melamine resin polycondensates, by customary processing methods for thermoplastic polymers,
A) is applied as a melt to a smoothing unit and taken off as sheet via conveyor belts and cut or are applied to and sealed on sheet webs comprising metal foils, polymeric films, paper webs or textile webs and are taken off as multi-component composites and finished, or
B) is discharged through a profile die and taken off as profile or sheet material, cut and finished, or
C) is discharged through an annular die, taken off as pipe, with injection of air, cut and finished, or
D) following the introduction of blowing agents, is discharged through a slot die and taken off as foamed sheet material, or
E) is discharged through the slot die of a pipe sheathing unit and applied in liquid melt form to, and sealed on, the rotating pipe, or
F) in injection moulding machines, preferably with three-section screws with a screw length of 18 to 24 D, at high injection rates and at mould temperatures of 5 to 70° C., is processed to injection mouldings, or
G) in melt spinning units is extruded by means of the melt pump through the capillary die into the blowing shaft and taken off as filaments or separated off by the melt-blown process as fibres, or discharged as a melt by the rotational spinning process into a shear field chamber using organic dispersants, to form fibrids, and processed further in downstream installations, or
H) is metered by the resin infusion process into an open mould with the semi-finished fibre product and shaped to laminates by the vacuum bag technology, or
I) is injected by the resin injection process into a lockable mould in which there are preforms of textile material, and are shaped to components and cured, or
K) is used for the melt impregnation of component blanks produced by the filament winding process, braiding process or pultrusion process,
and for full curing where appropriate the products are subjected to a thermal aftertreatment at temperatures of 180 to 220° C. and residence times of 30 to 120 min.
